(19) United States
(12) Patent Application Publication
(10) Pub. No.: US 2025/0262794 A1
(43) Pub. Date: Aug. 21, 2025

(54) PROCESS AND SYSTEM FOR ADDITIVE MANUFACTURING OF CARBON SCAFFOLDS

(71) Applicant: University of Delaware, Newark, DE (US)

(72) Inventors: Kun Fu, Newark, DE (US); Chunyan Zhang, Newark, DE (US)

(73) Assignee: University of Delaware, Newark, DE (US)

(21) Appl. No.: 18/857,615

(22) PCT Filed: Apr. 20, 2023
(86) PCT No.: PCT/US2023/019227

§ 371 Date: Oct. 17, 2024

Related U.S. Application Data
(60) Provisional application No. 63/332,747, filed on Apr. 20, 2022.

(51) Int. Cl. B28B 1/00; B28B 11/00; B33Y 10/00; B33Y 30/00; B33Y 40/20; C08J 5/24

(52) U.S. Cl. CPC B28B 1/001; B28B 11/00; B33Y 10/00; B33Y 30/00; B33Y 40/20; C08J 5/243; C08J 2363/00

(57) ABSTRACT

A process for additive manufacturing of a nanocomposite is disclosed. The process includes providing a uniform filament comprising a carbon fiber material and a polymer binder; dispensing the uniform filament to form a preform architecture that defines a first 3-dimensional bulk structure having a first set of volume-defining dimensions; heating the preform architecture to remove the polymer binder, thereby forming a porous carbon scaffold; and incorporating a matrix material into the porous carbon scaffold to form a third 3-dimensional bulk structure. The carbon scaffold defines a second 3-dimensional bulk structure having a second bulk volume, wherein the second bulk volume is equal to the first bulk volume within a tolerance of 10%. A system for additive manufacturing of a fiber reinforced composite is also disclosed. The system has a filament dispenser; means for moving the filament dispenser; a heater; and a matrix material applicator.

### CROSS-REFERENCE TO RELATED APPLICATIONS

This application claims priority from U.S. Provisional Application Ser. No. 63/332,747, titled “ADDITIVE MANUFACTURING OF CARBON SCAFFOLD,” filed Apr. 20, 2022, the entirety of which is incorporated herein by reference.

### BACKGROUND OF THE INVENTION

Nanocomposites are conventionally made with carbon nanoscale reinforcing materials, such as nanopowders, nanotubes, and nanoflakes. Composites reinforced by carbon nanomaterial assemblage containing distinct mesoscale features have the performance characteristics that take advantage of their kinetic evolution and mechanical response in a wide range of systems, including structural materials and energy storage materials. The ability to control heterogeneities of nanoscale building blocks within macroscale composites allows for the controlled creation of mesoscale features during composite fabrication and material development.

Nanomaterial mesoscale manipulation in composites traditionally mix nanoscale particles and matrix materials to spatially assembling nanomaterials into mesoscale architectures within matrix, including in situ nanomaterial synthesis and assembly, colloidal self-assembly, and field-assisted (electric and magnetic fields) assembly. More recently, additive manufacturing (AM) or three-dimensional (3D) printing methods, including but not limited to extrusion techniques, jetting processes, deposition methods, and powder bed fusion, provide opportunities to build macroscopic polymer nanocomposites with spatially and programmably controlled mesoscale architectures. However, conventional methods (e.g. a polymer-based system of fabricating nanocomposite with binder solution, or thermoplastic, or a narrow range of ultraviolet (UV)-curable resins containing low fraction of nanofillers) lack complex composite geometry feasibility, or ineffectively build mesoscale architectures within matrix, which cannot meet mechanical and durability requirements. In particular, no AM process, system, or technique has been reported to bring high content nanoscale materials combined with multiscale features (e.g. nanoscale manipulation, mesoscale architecture, and macroscale formation) to create spatially programmed nanocomposites with high solids content and multiscale tailorability.

Thus, it is of interest to develop a process and system for additively manufactured carbon nanocomposites containing carbon nanotubes (CNTs) and thermoset epoxy, leading to multiscale CNTs tailorability, performance improvement, and 3D complex geometry feasibility. This process and system can produce nanomaterial-assembled architectures with 3D geometry and multiscale features, and can incorporate a wide range of matrix materials, such as polymer, metal, and ceramic, to fabricate nanocomposites for new device structures and applications.

### SUMMARY OF THE INVENTION

The drawbacks of conventional techniques of manufacturing nanocomposites are addressed in many respects by processes and systems in accordance with the invention.

One aspect of the invention comprises a process for additive manufacturing of a nanocomposite. The process comprises providing a uniform filament comprising a carbon fiber material and a polymer binder. The process also includes dispensing the uniform filament to form a preform architecture that defines a first 3-dimensional bulk structure having a first bulk volume. The process comprises heating the preform architecture to remove the polymer binder, thereby forming a porous carbon scaffold that defines a second 3-dimensional bulk structure having a second bulk volume. The second bulk volume is equal to the first bulk volume within a tolerance of 10%. The process also includes incorporating a matrix material into the porous carbon scaffold to form a third 3-dimensional bulk structure.

Another aspect of the invention comprises a system for additive manufacturing of a nanocomposite. The system includes a filament dispenser configured to extrude a homogenous mixture of fiber material comprising carbon nanotubes (CNTs) and polymer binder through a nozzle to form a uniform filament. The system also comprises means for moving the filament dispenser relative to a dispensing location in a filament deposition direction to form a preform architecture that defines a bulk 3-dimensional structure having a first bulk volume with the CNTs shear-aligned in the filament deposition direction. The system includes a heater configured to heat the preform architecture to remove the polymer binder, thereby forming a porous carbon scaffold defining a second 3-dimensional bulk structure having a second bulk volume. The second bulk volume is equal to the first bulk volume within a tolerance of 10%. The system comprises a matrix material applicator configured to incorporate a matrix material into the porous carbon scaffold.

### BRIEF DESCRIPTION OF THE DRAWINGS

The invention is best understood from the following detailed description when read in connection with the accompanying drawings, with like elements having the same reference numerals. When a plurality of similar elements are present, a single reference numeral may be assigned to the plurality of similar elements with a small letter designation referring to specific elements. When referring to the elements collectively or to a non-specific one or more of the elements, the small letter designation may be dropped. This emphasizes that according to common practice, the various features of the drawings are not drawn to scale unless otherwise indicated. On the contrary, the dimensions of the various features may be expanded or reduced for clarity. Included in the drawings are the following figures:

FIG. 1A depicts a nanocomposite fabrication process in accordance with an exemplary embodiment of the invention;

FIG. 1B depicts a schematic illustration of the nanocomposite fabrication process of FIG. 1A;

FIG. 2A depicts a schematic illustration of a nanocomposite fabrication process of FIG. 1;

FIG. 2B depict images of a preform architecture, a porous carbon scaffold, and a nanocomposite fabricated in accordance with the process of 2A;

FIG. 3A depicts a schematic illustration of a preform architecture fabricated in accordance with an exemplary embodiment of the invention;

FIG. 3B depicts a scanning electron microscopy (SEM) image of a portion of the preform architecture of FIG. 3A;

FIG. 3C depicts a probabilistic spectrum of overcrossing between exemplary components of the preform architecture of FIG. 3A in accordance with an exemplary embodiment of the invention;

FIG. 3D depicts a schematic illustration of H-bonds formed at the interface between exemplary components of the preform architecture of FIG. 3A;

FIG. 3E depict images of the preform architecture of FIG. 3A after being heated in air in accordance with an exemplary embodiment of the invention;

FIG. 3F depict coarse-grained molecular dynamics (MD) modeling images of the preform architecture of FIG. 3A, after an exemplary deformation test;

FIG. 3G depict MD modeling images of a portion of the preform architecture of FIG. 3D;

FIG. 4A depicts a schematic illustration of a porous carbon scaffold fabricated in accordance with an exemplary embodiment of the invention;

FIG. 4B depict images of a porous carbon scaffold fabricated in accordance with another exemplary embodiment of the invention;

FIG. 4C depict images of exemplary porous carbon scaffold having complex geometry features;

FIG. 5A depicts a schematic illustration of a nanocomposite in accordance with an exemplary embodiment of the invention;

FIG. 5B depicts SEM images of a surface and interior morphology of the nanocomposite of FIG. 5A;

FIG. 5C depict images of exemplary nanocomposites having complex geometry;

FIG. 6A depict images of an exemplary multiscale structural battery electrode;

FIG. 6B depict images of carbon monolith catalysis with tunable geometries;

FIG. 7A depicts SEM images of exemplary tailorable directional distribution of fiber material of a porous carbon scaffold fabricated in accordance with an exemplary embodiment of the invention;

FIG. 7B depicts x-ray diffractograms (XRD) data for assessing alignment of carbon fiber material;

FIG. 8 depicts a graph showing a comparison of compressive strength and solid content of nanocomposites fabricated in accordance with an exemplary embodiment of the invention and prior art carbon nanocomposites and carbon fiber composites;

FIG. 9 depicts a radar plot showing the inventive features in contrast with prior art techniques;

FIG. 10 depicts a schematic illustration of a system for additive manufacturing of a nanocomposite in accordance with an exemplary embodiment of the invention;

FIG. 11 depicts a fabrication an exemplary uniform filament in accordance with an exemplary embodiment of the invention;

FIG. 12 depicts coarse-grained MD computational models of prior art composite and an exemplary uniform filament;

FIG. 13 depicts calculations of density as a function of temperature to determine high-thermal stability of nanocomposites fabricated by process of FIG. 1A;

FIG. 14 depict data assessments of exemplary nanocomposites fabricated by process of FIG. 1A; and

FIG. 15 depicts a comparison of features of representative existing technologies and the exemplary process of FIG. 1A.

### DETAILED DESCRIPTION OF THE INVENTION

Aspects of this invention relate to a method and system for additive manufacturing (AM), and more particularly, to a fabrication method and system using additively manufactured carbon nanocomposites, capable of being combined with multiscale features to fabricate nanomaterial-assembled architectures with complex geometries and functionalities.

Although the invention is illustrated and described herein with reference to specific embodiments, the invention is not intended to be limited to the details shown. Rather, various modifications may be made in the details within the scope and range of equivalents of the claims and without departing from the invention.

Additionally, various forms and embodiments of the invention are illustrated in the figures. It will be appreciated that the combination and arrangement of some or all features of any of the embodiments with other embodiments is specifically contemplated herein. Accordingly, this detailed disclosure expressly includes the specific embodiments illustrated herein, combinations and sub-combinations of features of the illustrated embodiments, and variations of the illustrated embodiments.

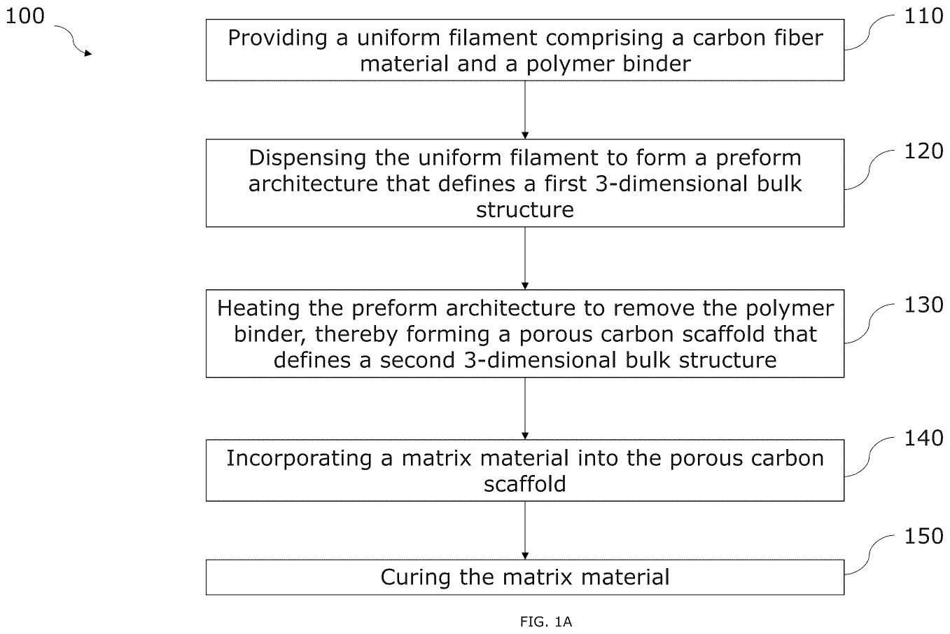

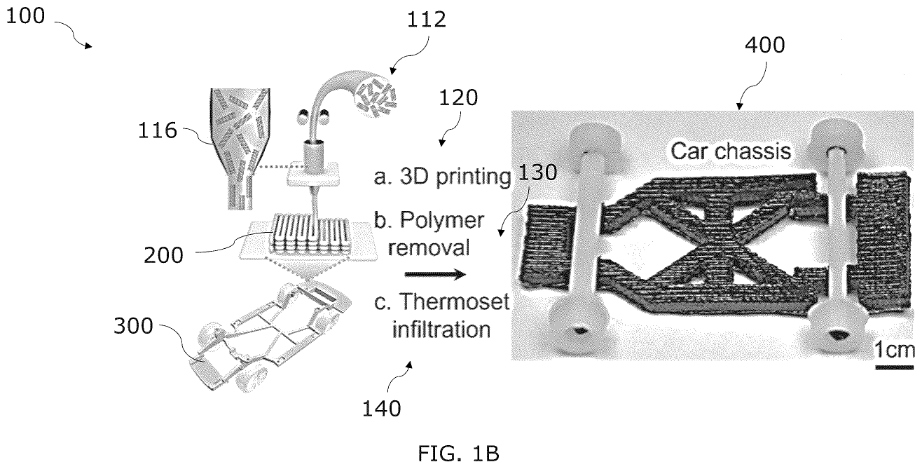

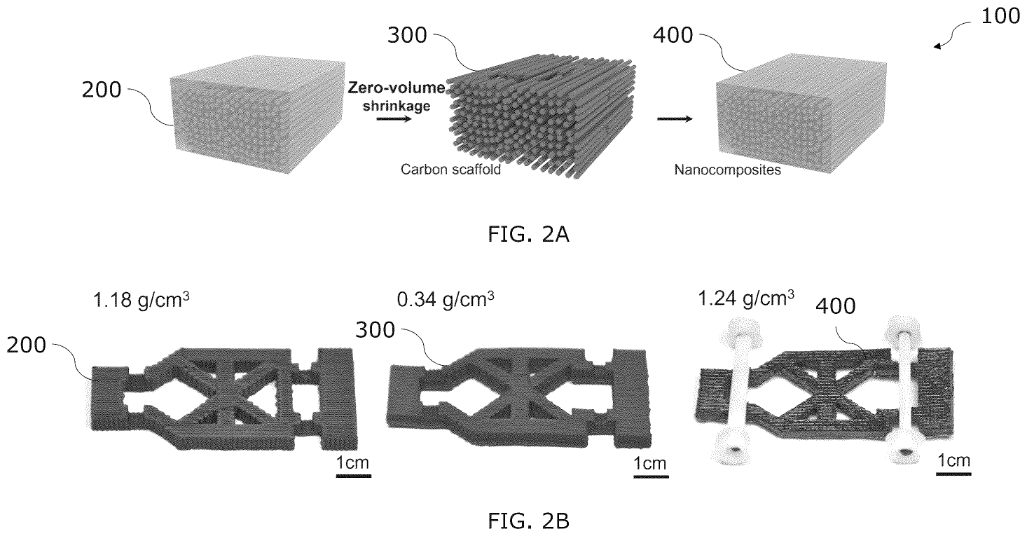

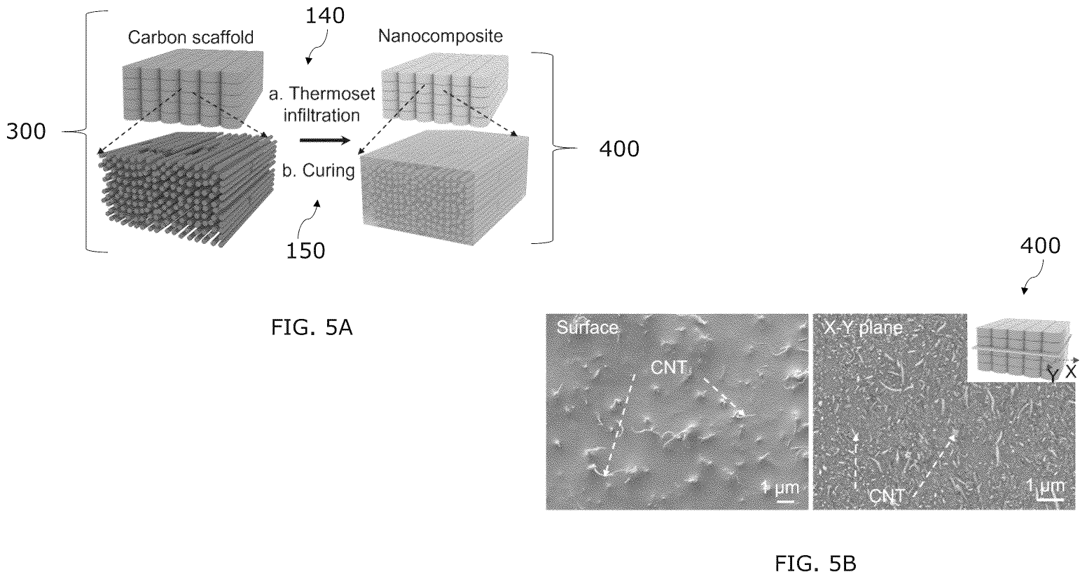

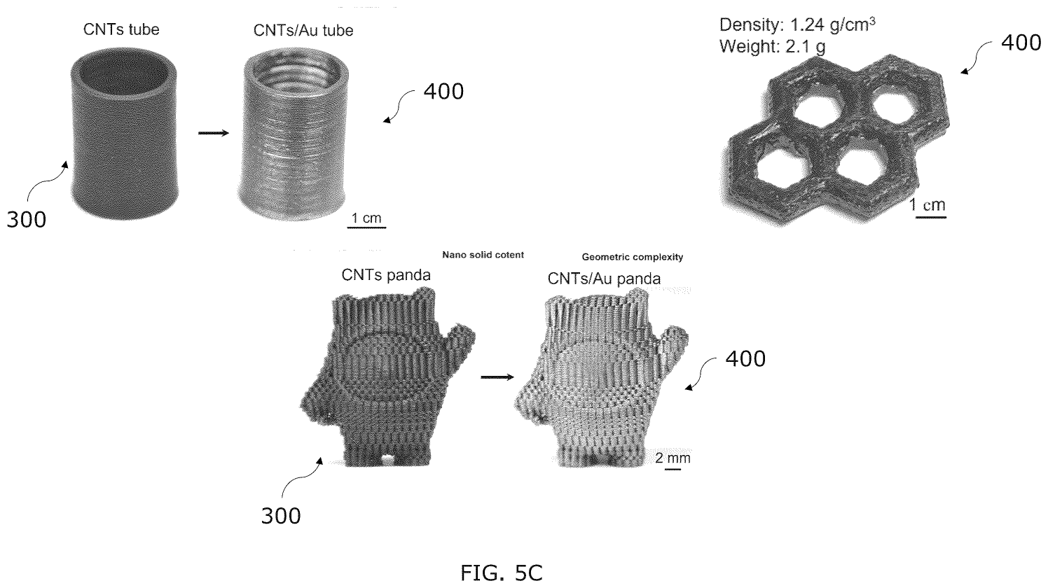

FIGS. 1A-1B and 2A-2B illustrate an exemplary process 100 in accordance with aspects of the present invention. Process 100 includes a composite fabrication technique, such as Composite Architected Mesoscale Process (CAMP), which brings high-content nanoscale materials to combine with multiscale features (e.g., nanoscale manipulation, mesoscale architecture, and macroscale formation) to enable spatially programmed composite designs. In general, the process comprises a step 110 of providing a uniform filament 112; a step 120 of dispensing the uniform filament to form a preform architecture 200 (FIGS. 2A-2B); a step 130 of heating the preform architecture 200, thereby forming a porous carbon scaffold 300 (FIGS. 2A-2B); and a step 140 incorporating a matrix material 142 into the porous carbon scaffold 300 to form a third 3-dimensional bulk structure 400 (FIGS. 2A-2B). Additionally or optionally, process 100 includes a step 150 of curing the matrix material 142 to form the nanocomposite 500 after dispensing the matrix material 142 on the carbon scaffold 300 (FIG. 5A). Details of the process 100 are further discussed below.

In an exemplary embodiment, step 110 includes providing a uniform filament 112 comprising a carbon fiber material 114 and a polymer binder 116. The carbon fiber material 114 comprises one or more carbon nanopowder, carbon nanotubes (CNTs), nanoflakes, graphene, graphite, copper, micro diamonds, aluminum nitride, boron nitride, and chopped virgin or recycled carbon fibers. In one example, carbon fiber material 114 comprises carbon nanotubes (CNTs) and polymer binder 116 comprises a thermoplastic material. In an exemplary embodiment, step 110 comprises preparing the uniform filament 112. Preparing the uniform filament includes mixing the carbon fiber material 114 and the polymer binder 116 into a homogenous mixture, drying the homogenous mixture to form pellets, and extruding the pellets to form the uniform filament 112.

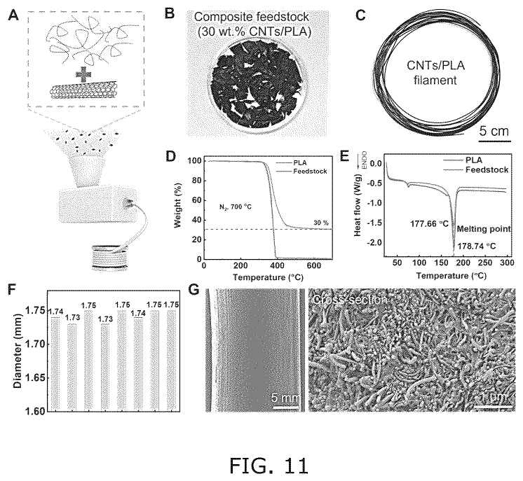

FIG. 11 depicts a fabrication and characterization of the uniform filament 112 comprising carbon fiber material 114 and polymer binder 116. Specifically, label (A) of FIG. 11 shows a schematic diagram of a process of making or providing an exemplary uniform filament 112 comprising carbon fiber material and a polymer binder 116. Label (B) shows that in an exemplary embodiment, the uniform filament 112 is made with a pellet feedstock containing 30 wt. % carbon fiber material 114, such as CNTs, and 70 wt. % polymer binder 116, such as polylactic acid (PLA). Label (C) shows a photo of the 6 m long filament 112 produced by the process shown in label (A) of FIG. 11. Label (D) shows a thermogravimetric (TGA) analysis of pure PLA and 30 wt. % CNTs/PLA feedstock in a nitrogen environment, which confirmed the CNTs content (30 wt. %) in the feedstock. In one example, the polymer binder 116 is completely removed above 400° C. in nitrogen. Label (E) shows that differential scanning calorimetry (DSC) curves of pure PLA and composite feedstock was implemented, showing that the melting temperature of feedstock is 177.66° C. Ultimately, a 6 m long CNTs-bonded uniform filament 112 was produced (as shown in labels F to G in FIG. 11). Label (F) shows a diameter distribution histogram of the manufactured filament 112, with the manufactured filament 112 being produced by a vertical formation line including filament extrusion and tensioning to form uniform filaments having an average length of 1.75 mm. In an exemplary embodiment, the filament 112 has a uniform diameter and smooth surface, which permits the extruder gears to grip the filament 112 tightly and the bearings to hold pressure uniformly on the filament 112 for a continuous feeding without in-chamber breaking. This is confirmed by label (G) in FIG. 11, which depicts Scanning Electron microscopy (SEM) images of filament 112. A uniform distribution of the CNTs 114 in the PLA matrix 116 can be observed as well as CNTs 114 pre-aligned in the longitudinal direction of filament 112.

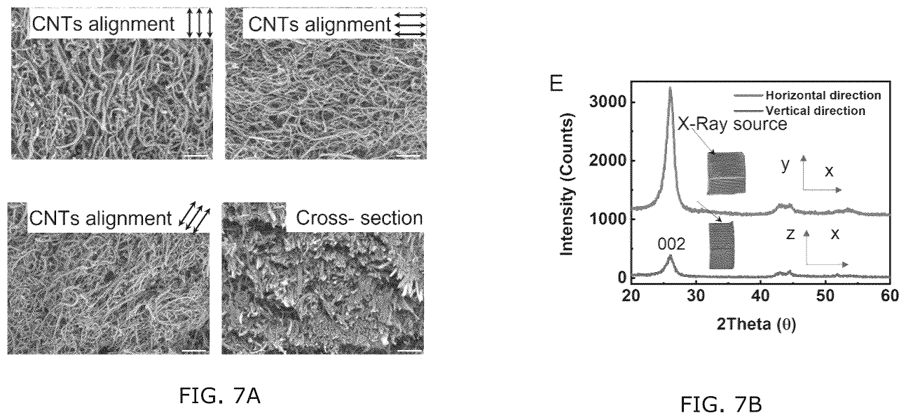

In an exemplary embodiment, the process 100 also includes a step 120 of dispensing the uniform filament 112 to form a preform architecture 200. Additionally or optionally, step 120 further comprises dispensing a plurality of layers of uniform filament 112, one layer on top of another to form the preform architecture 200. The preform architecture 200 (e.g., “green” part containing a polymer-bonded mesoscale carbon architecture) defines a first 3-dimensional bulk structure having a first bulk volume. In one example, when the carbon fiber material 114 comprises CNTs, the uniform filament 112 is extruded in a printing direction, wherein the CNTs 114 in the extruded filament 112 are oriented along the printing direction. Specifically, the uniform filament 112 is extruded through a nozzle 116 (FIG. 1B) that causes shear-induced alignment of the CNTs 114. In one example, the uniform filament 112 comprising CNTs/PLA is dispensed or extruded through a 0.4 mm high-pressure nozzle. Extrusion through the printing nozzle 116 causes massive alignment of CNTs under shear flow of CNTs and plastic 116 (e.g. PLA) along the filament deposition direction. FIG. 7A shows the directional distribution of CNTs 114 at different printing directions. Specifically, the CNTs 114 are unidirectionally aligned in the cross-section plane and are vertical to the printed layer. X-ray diffractograms (XRD) data further confirmed the CNTs alignment. XRD were conducted in two different orientations of printed CNTs samples. FIG. 7B shows the two samples printed with vertical (out-plane alignment) and horizontal (in-plane alignment) directions, respectively. The alignment degree of CNTs was confirmed by tracking the intensity of the (002) plane, corresponding to the inter-planar spacing of 0.34 nm. Compared to the vertical direction with a density of ˜400 counts, the horizontal direction with a density of ˜2200 counts exhibited about 5× higher peak in the (002) plane at 26°, confirming that CNTs was oriented along the printing direction. Additionally or optionally, after performing further multiscale topological optimization design, orientation of the CNTs can be encoded into a spatial mesoscale development towards macroscopic components with broad structural and functional programmability.

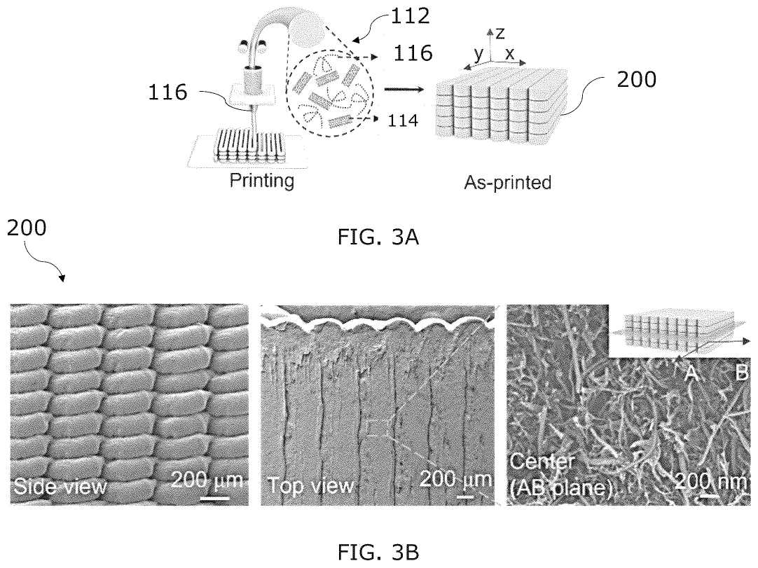

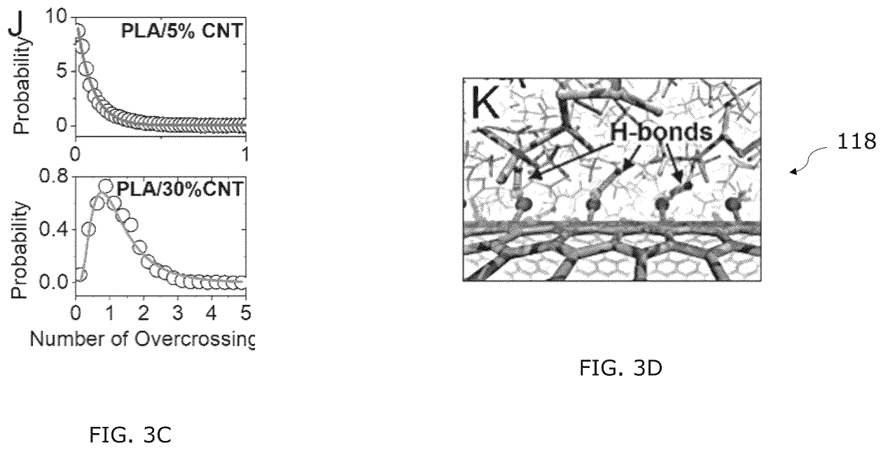

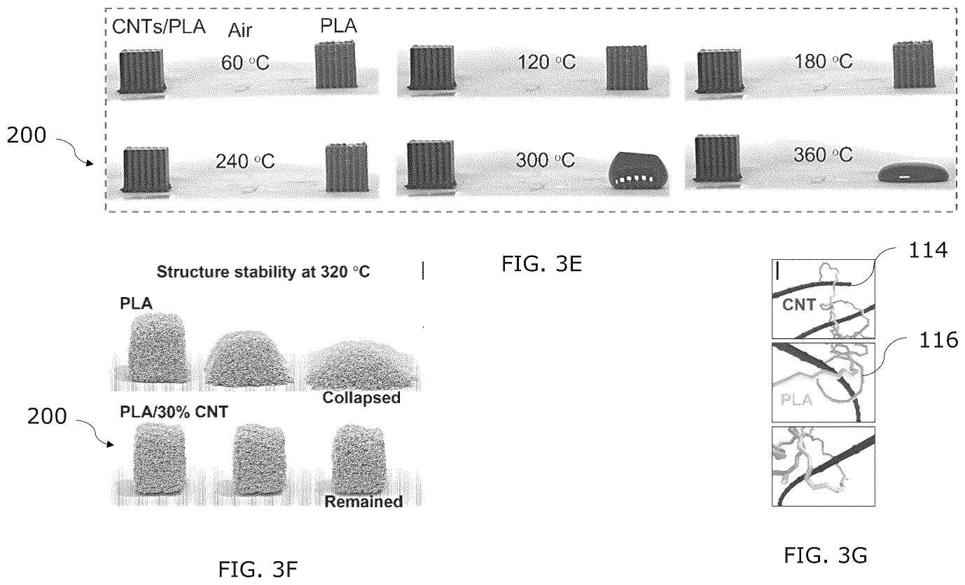

FIG. 3B shows scanning electron microscopy (SEM) images of the preform architecture 200 from different views. The preform architecture 200 is illustrated as being a closely-packed structure without gaps, i.e., no bubbles or voids were trapped in between extruded layers of filament 112. In an exemplary embodiment, each layer of filament 112 has an average width of 0.4 mm. The magnified views of FIG. 3B show that the CNTs 114 were densely embedded in PLA matrix 116 with an even distribution, resulting from good compatibility of PLA 116 and CNTs 114 after functionalization in the feedstock (FIG. 11).

In an exemplary embodiment, process 100 comprises a heating step 130, wherein the preform architecture 200 is heated to remove the polymer binder 116, thereby forming a porous carbon scaffold 300. Thermomechanical stability brought by CNTs 114 reinforcement is fundamental to the transition between the preform architecture 200 and porous carbon scaffold 300 (i.e., from “green” state to “brown” state), which permits assembling nanoscale building materials into multiscale architectures.

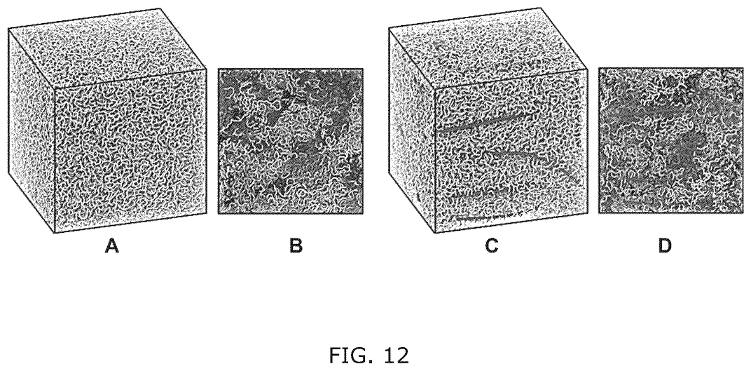

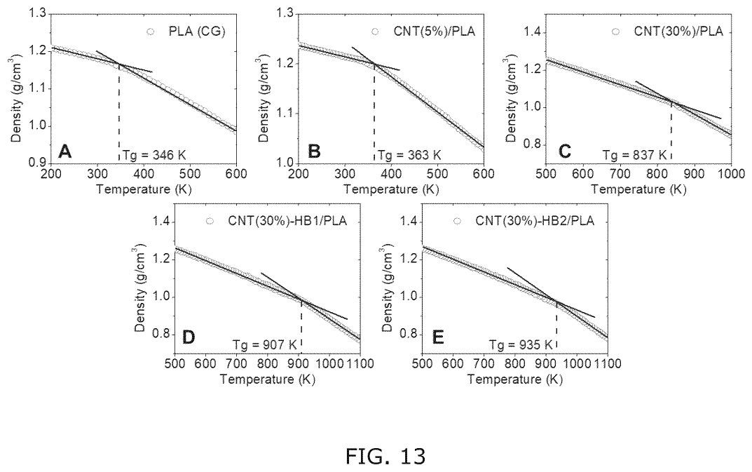

To elucidate the underlying mechanisms, the molecular origin of the high-thermal stability of uniform filament 112 comprising CNTs/PLA is evaluated via coarse-grained molecular dynamics (MD) with simulated gravitational loading at 320° C. (FIG. 12). FIG. 12 shows a coarse-grained MD computational models of (labels A-B of FIG. 12) PLA and (labels C-D of FIG. 12) the CNT/PLA composite, such as uniform filament 112. Labels (A) and (C) of FIG. 12 are 3D views where gold and red represent PLA and CNT chains, respectively. Labels (B) and (D) of FIG. 12 are front views. FIG. 3F shows that under simulated gravitational loads at 320° C., a comparative PLA structure rapidly collapsed, whereas the geometry of the inventive preform architecture 200 comprising a 30 wt. % CNT/PLA structure remained intact, indicating a drastic reduction of PLA 116 mobility. The collapse of the comparative PLA structure is due to the glass transition temperature (T_{g}) of PLA 116, which is calculated to be 73° C. and above T_{g}, PLA's molecular chains become increasingly mobile, thereby leading to glass transition, melting, and collapse. By comparison, preform architecture 200 comprising a 30 wt. % CNT/PLA structure is predicted to have T_{g}=560˜660° C. (FIG. 13). FIG. 13 shows a calculation of density as a function of temperature. Specifically, coarse-grained models were used for the calculation of glass transition temperature (T_{g}) of (A) PLA, (B) CNT (5 wt. %)/PLA, (C) CNT (30 wt. %)/PLA, (D) CNT (30 wt. %)-OH/PLA with 3.25% coverage of —OH groups on CNT, and (E) CNT (30 wt. %)-OH/PLA with 6.5% coverage of-OH groups on CNT.

The thermomechanical stability of preform architecture 200 comprising CNTs/PLA was also confirmed when a CNTs/PLA sample was subjected to a heating step in air. As illustrated, in FIG. 3E, the sample preform architecture 200 showed little to no thermal-induced melting or structural collapse, which is in stark contrast to the PLA sample (shown as being deformed and completely melted due to temperature increases. Thus, the sample preform architecture 200 remained geometrically intact during a heating step.

Additionally, the outstanding thermal stability of the preform architecture 200 comprising nanofiller/PLA composite (e.g. carbon nanotubes 114 and polymer binder 116) is due, at least in part, to the highly entangled molecular network 118 (FIG. 3D) formed between PLA 116 and mechanically strong nanofillers, such as CNTs 114. Namely, long PLA 116 molecular chains wrap around CNTs 114, forming entangled structures, as shown in FIG. 3G. The CNT-PLA intermolecular entanglement 118, together with PLA's intrinsic inter- and intra-chain entanglement, leads to an interconnected molecular network 118 that significantly limits polymer motion and improves thermal stability. Thus, in an exemplary embodiment, the CNTs 114 in the extruded uniform filament 112 form a locally aligned, globally distributed structure, in which the CNTs 114 and the polymer binder 116 form an interconnected molecular network with CNT/polymer-binder entanglement 118.

The degree or level of CNT-PLA intermolecular entanglement depends highly on the concentration of CNTs, as shown in FIG. 3C, which depicts a probabilistic spectrum of overcrossing between exemplary components of the preform architecture 200. In one example, with 5 wt. % CNTs 114, the probabilistic spectrum exponentially decays, suggesting a low possibility of forming CNT-PLA entanglement. However, as the amount of CNT 114 increases to 30 wt. %, the probabilistic spectrum shows a lognormal distribution peaked at 1.12 overcrossing per PLA chain, indicating a high level of entanglement and enhanced thermal stability. Accordingly, the uniform filament 112 comprises an amount of fiber material 114 in a range between 25% to 99% by weight.

In an exemplary embodiment, the CNT-PLA intermolecular entanglement can be further boosted by the H-bonding formed between PLA and functional groups commonly seen on CNTs (e.g., OH) (FIG. 3D). In particular, the fiber material 114 is a functionalized fiber material comprising a percentage of functional groups that form hydrogen bonds between the polymer binder 116 and the functional groups in the interconnected molecular network 118 (FIG. 3D). H-bonds are known in many studies to enhance interfacial bonding between materials, thereby greatly improving mechanical and thermal properties. Functionalizing the CNT 114 with 3.25% and 6.50%-OH groups increases the interfacial energy of adhesion by about 9.72% and 22.16%, and enhances T_{g} from 564° C. to 634° C. and 662° C., respectively. In summary, the CNT-PLA intermolecular entanglement and interfacial H-bonds synergistically interlock PLA chains to improve the structural stability of CNT/PLA composite at elevated temperatures. Similar mechanisms to retain and/or improve thermomechanical stability of preform architecture 200 in preparation for its transition to the porous carbon scaffold 300 can apply to other nanofillers or carbon fiber materials 114, including but not limited to graphene and graphite.

The importance of the thermomechanical stability of preform architecture 200 is confirmed by a storage modulus measurement using dynamic mechanical analysis (DMA) to understand feedstock thermomechanical property in preparation for the heating step 130. It was observed that the storage modulus of CNTs/PLA composite is higher than that of neat PLA in the glassy (at 40° C.) and rubbery (at 80° C.) state. The highly-loaded CNTs 114 which restrict the mobility of the PLA 116 chains provide extra stiffness for performance of the heating step 130.

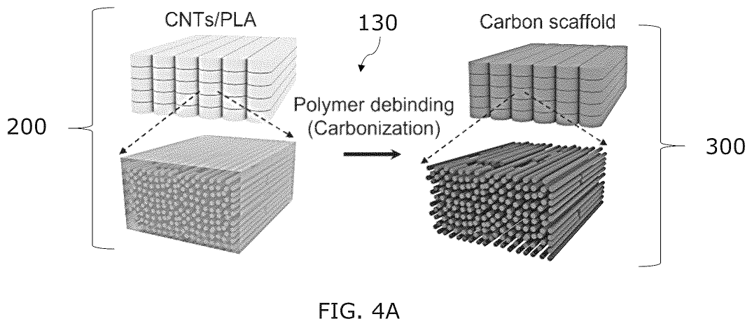

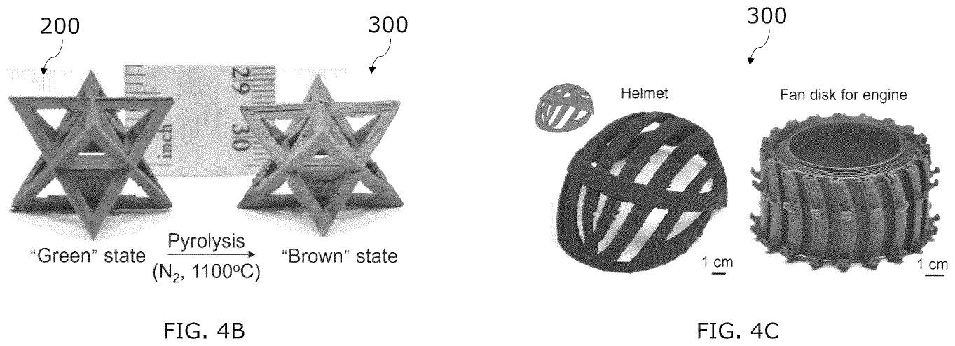

As stated above, the preform architecture 200 is heated to remove the polymer binder 116, thereby transforming the preform architecture 200 comprising polymer-bounded CNTs 114 to a carbon form. Full CNTs parts with complex geometry features can be achieved with process 100, as shown in FIG. 4C. It should be understood that the illustrated geometries, shapes, and contours of the preform architecture 200, the carbon scaffold 300, and/or other bulk structures are not intended to be limiting.

In an exemplary embodiment, the heating step 130 comprises carbonizing the preform architecture 200 in an inert atmosphere at 1100° C. In another exemplary embodiment, the heating step 130 comprises heating the preform architecture 200 from room temperature to 1100° C. to completely remove PLA 116, which is then slowly cooled down to form a full CNTs part. In the early stage of the temperature ramp, the heating ramp rate was low and the polymer binder 116 was decomposed slowly in air. As the temperature reaches its peak, the remaining polymer 116 was carbonized and no dimensional change was observed after further thermal treatment in N₂.

Conventionally, the transition from “green” to “brown” part (or between preform architecture 200 and carbon scaffold 300) includes volume shrinkage. In contrast, inventive process 100 and more particularly, step 130 shows near a zero-volume shrinkage. As described herein and throughout the specification, “zero-volume shrinkage” (or non-shrinkage) refers to a lack of shrinkage (i.e. change in total volume or bulk volume) of the overall geometry of a subject part. As is understood in the art, “total volume” or “bulk volume” is the volume defined by the exterior dimensions of an object (e.g., for a cube, the volume d³ wherein d=the dimension of one side of the cube), including the volume represented by any pores contained within the exterior of the object. Total volume may also be expressed as the total of particle volume, interparticle void volume, and internal pore volume. As used herein the term “bulk structure” refers to the structure that defines the total volume or bulk volume.

For clarity regarding “zero-volume shrinkage” the porous carbon scaffold 300 defines a second 3-dimensional bulk structure. This second 3-dimensional bulk structure has a second bulk volume. In one example, the first bulk volume comprises dimensions of a geometry that define the bulk structural periphery of the preform architecture 200. Additionally, the second bulk volume comprises dimensions of a geometry that define the bulk structural periphery porous carbon scaffold 300. In an exemplary embodiment, the second bulk volume-is essentially equal to the first bulk volume within a tolerance of 10%. By “essentially equal,” one skilled in the art should understand that no dimension in the second bulk volume is different from those of in the first bulk volume by more than a factor of 10%. In this way, a “near replica transformation” is achieved.

As illustrated in FIG. 4B, after step 130 of carbonizing preform architecture 200 comprising CNTs/PLA in the form of an octet-truss lattice unit cell, a carbon scaffold 300 in the form of an octet-truss lattice unit cell is formed. On the macroscale, the bulk structure 300 is comprised of hierarchical octet lattice cells and formed in a layer-by-layer manner. On the lower scale, the structure is made of CNTs with a high degree of orientation and a porous structure is formed after the polymer component is removed. Also, a non-volume change is observed between the preform architecture 200 and carbon scaffold 300, as shown in FIG. 4B. The non-volume change thereby makes it possible to enable a 100% replicate of model design into a real part.

In an exemplary embodiment, as shown in FIG. 5A, the process 100 also includes a step 140 of incorporating the matrix material 142 into the porous carbon scaffold 300 to form a third 3-dimensional bulk structure. In an exemplary embodiment, the matrix material 142 comprises a material selected from the group consisting of: thermosetting polymer, thermoplastic, metal, ceramic material, and combinations thereof. Additionally or optionally, the matrix material 142 comprises a material selected from the group consisting of: epoxy, polysiloxane, and combinations thereof. In one example, when the matrix material 142 comprises thermosetting polymer or metal, and the matrix material 140 is infiltrated into the porous carbon scaffold 300 in a liquid or molten form. In another example, when the matrix material 142 comprises ceramic, the matrix material 142 is incorporated into the porous carbon scaffold 300 as a ceramic precursor solution or preceramic polymer. In still another example, when the matrix material 142 comprises a thermosetting polymer and the thermosetting polymer includes an epoxy. In an exemplary embodiment, the epoxy comprises a two-part system comprising resin and a curing agent, and the process 100 further comprises mixing the resin and the curing agent prior to incorporating the matrix material 142 into the porous carbon scaffold 300.

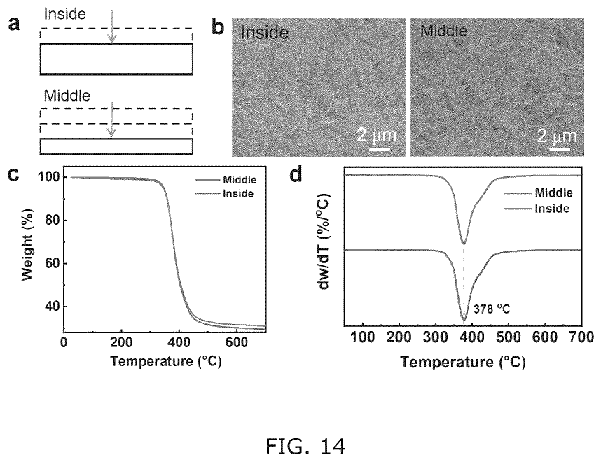

In an exemplary embodiment, step 130 comprises a vacuum-assist liquid resin transfer method is used to allow full infiltration of liquid epoxy resin in the carbon scaffold 300. FIG. 5B shows the surface and interior (on the X-Y plane) morphology of the resulting third 3-dimensional bulk structure (e.g. epoxy nanocomposites). FIG. 14 shows: (A) a schematic diagram of the SEM images of different position of CNT/thermoset nanocomposite; (B) SEM images of thermoset nanocomposites; (C) TGA of the thermoset nanocomposite; and (D) differential thermogravimetric (dw/dT) plots of nanocomposite at different locations. As illustrated by FIG. 14, it can be observed that CNTs were fully embedded in an epoxy matrix after step 130. In particular, the CNTs weight ratio was calculated based on the TGA results, showing that there is ˜25 wt. % CNTs in the finished nanocomposites.

Turning now to FIG. 5C, images of nanocomposites having complex geometries are shown, with one being in the form of a tube and another as a panda. In other examples, a 3D honeycomb structure is formed, and under a simulation was observed to have the capability to support the weight of a 1455-Kg car, corresponding to 700,000 times the weight of the 3D honeycomb sample used in testing. No damage was noticed on the structure.

As will be further discussed in the example below, the inventive process exhibits an array of features that are desirable for the manufacturing of nanocomposites, but generally difficult to achieve using existing AM techniques or other methods. FIG. 9 evaluates five aspects: zero shrinking from “green” to “brown” state, nanoscale tailorability, geometric complexity, nanosolid content, and mechanical performance of inventive process 100. In these five aspects, the inventive process 100 is assessed against related AM techniques including, Direct Ink Writing (DIW), Fused Deposition Modeling (FFF), Stereolithography (SLA), Powder bed fusion (PBF) and Molding (as further shown in Tables 2 and 3 below). The inventive process 100 includes zero-shrinking “green-to-brown” state of transition and enables manufacturing nanocomposite with 3D geometry, multiscale features and nanoscale tailorability, thereby achieving high mechanical property.

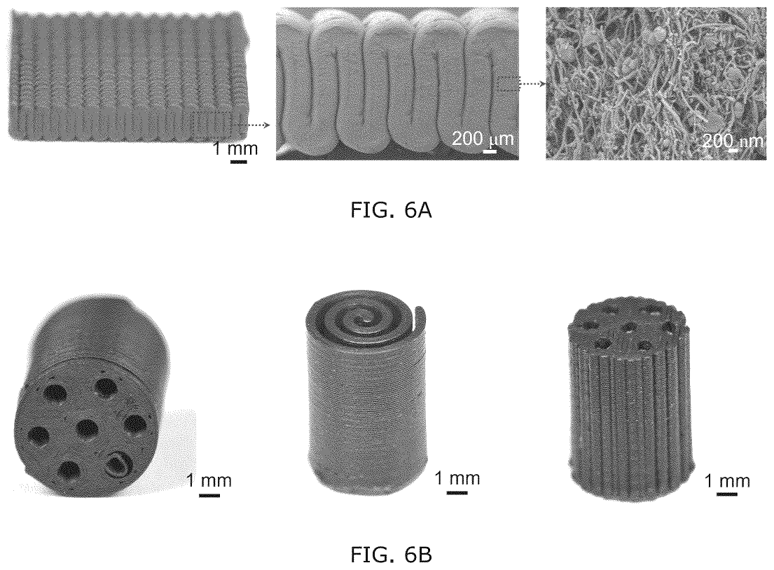

In an exemplary embodiment, applications made possible by process 100 includes structural battery electrodes and carbon monolith catalysis (FIGS. 6A-6B) or sensors (not shown), optionally with tunable geometries. In one example, process 100 includes forming the 3-dimensional structure with a tunable geometry that defines a structural battery electrode or a carbon monolith catalyst. Tunable parameters may include differences in material orientation or gradients in material distribution through the thickness of structures made by the methods and processes discussed herein. For example, material orientation through the thickness of the structural battery electrode, or gradient materials distribution through the thickness of the structural battery electrode, may be varied to tune the geometry thereof. FIG. 6 illustrates structural battery electrodes and monolith catalysis prepared by process 100. In particular, FIG. 6 shows (A) length-scale breakdown of the multiscale structural battery electrodes and (B) photographs of carbon monolith catalysis with tunable geometries.

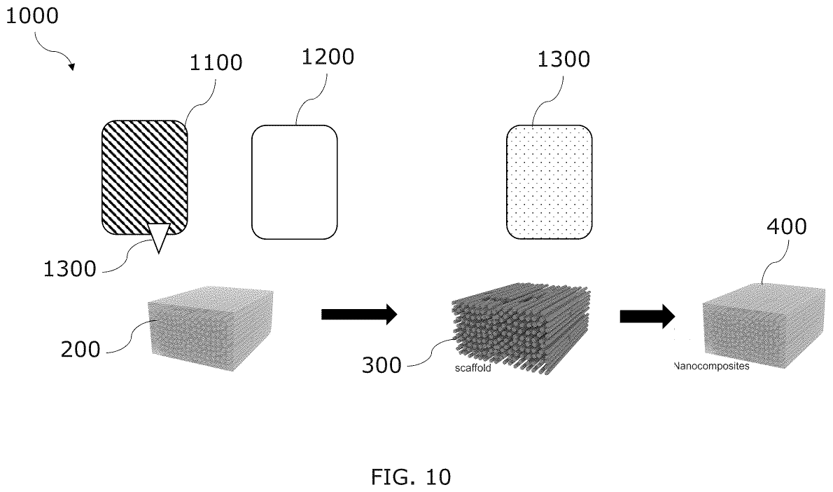

Another aspect of the invention comprises a system for additive manufacturing of a nanocomposite. Referring to FIG. 10, the system 1000 generally includes a filament dispenser 1100; a means (not shown) for moving the filament dispenser 1100 relative to a dispensing location in a filament deposition direction to form a preform architecture 200; a heater 1200 configured to heat the preform architecture 200 to remove a polymer binder 116 and form a porous carbon scaffold 300; and a matrix material applicator 1300 configured to incorporate a matrix material 142 into the porous carbon scaffold 300.

In an exemplary embodiment, the filament dispenser 1100 is configured to extrude a homogenous mixture of carbon fiber material 114 and polymer binder 116. As stated above, carbon fiber material 114 comprises CNTs and polymer binder 116 comprises PLA. The homogenous mixture is dispensed through a nozzle 116 to form a uniform filament 112. In this way, the means for moving the filament dispenser 1100 relative to the dispensing location in the filament deposition direction dispenses the homogenous mixture in such a way that a preform architecture 200 is formed. In one example, a plurality of layers of uniform filament 112, one layer on top of another, are dispensed via the nozzle 116 and by the means for moving the filament dispenser 1100 relative to the dispensing location in the filament deposition direction, to form the preform architecture 200. The preform architecture 200 defines a bulk 3-dimensional structure having a first bulk volume, with the CNTs being shear-aligned in the filament deposition direction. In operation, the heater is configured to heat the preform architecture 200 to remove the polymer binder 116, thereby forming the porous carbon scaffold 300. The porous carbon scaffold 300 defines a second 3-dimensional bulk structure having a second bulk volume. As indicated above, the second bulk volume is essentially equal to the first bulk volume within a tolerance of 10%.

### EXAMPLE

The co-inventors assessed the feasibility and functionality of the components of the inventive process and system, as well as verified any updates or improvements made. The prototype preform architecture, porous carbon scaffold, and nanocomposite was subjected to various mechanical and clinical testing as detailed herein.

### Materials

The carbon nanotubes (CNTs) powder provided was designed and manufactured by Cheaptubes of Grafton, Vermont, USA. The length and diameter of the CNTs are in a range between 10-30 μm and 20-30 nm, respectively. The CNTs were randomly oriented in the powder and the powder was sealed and stored in a drying oven. The binder material, such as a thermoset resin, is high temperature infusion epoxy resin 4600, as designed and manufactured by Fiberglast of Brookville, Ohio, USA. The mixing ratio of the epoxy and hardener is 5:1 by weight. The curing temperature profile was 65° C. for 3 h, 120° C. for 3h then 190° C. for 4 h at a heating rate of 3° C./min followed by cooling down naturally to room temperature.

### Fabrication of High-CNTs Fraction Filament

The CNTs were functionalized to increase their solubility and dispersity in polymer. It was then added to the polymer solution to obtain homogeneously distributed CNTs/polymer mixture by blending for 4 hours, followed by air dried at room temperature to get the feedstock materials. Next, this feedstock was chopped into the smaller pellets for extrusion use. Finally, the uniform filament comprising a carbon fabric material and a polymer binding material, was achieved by extruding for several times at 200° C. to further increase the dispersity of the CNTs.

### Fabrication of the Nanocomposite

The prepared uniform filament was fed into a customized printer to obtain the preform architecture (e.g. “green” part). It was then carbonized in the inert atmosphere at 1100° C. with a ramp rate of 5° C./min for half hours to obtain the porous carbons scaffold (e.g. full carbon architecture or “brown” part). Next, a vacuum-assist liquid resin transfer method is performed to allow full incorporation or situation of liquid epoxy resin in the preformed 3D CNTs architecture of the porous carbons scaffold, followed by post curing to make 3D thermoset nanocomposites (the “finished” nanocomposite or part).

### Material Characterization

A scanning electron microscope, such as the Scanning Electron Microscope ((SEM)/Focused Ion Beam (FIB) Auriga® 60 CrossBeam® as designed and manufactured by Zeiss of Germany, was utilized to characterize the morphology of the extruded uniform filament, such as the extruded CNT/polymer filament; as-printed CNTs/PLA (or preform architecture); and the CNT/thermoset resin composite. Thermogravimetric analysis (TGA) is performed to obtain the polymer ratio in the composite pellet under Nitrogen condition for up to 700° C. with a heating rate of 10° C./min. The differential scanning calorimetry (DSC) measurements were carried out on a TA discovery DSC equipped with a cooling system. The temperature was controlled from 30° C. to 300° C. with a heating rate of 20° C./min under nitrogen atmosphere. The alignment of CNTs were examined by x-ray diffraction (XRD) and SEM. An x-ray-diffractometer, such as the D8 XRD (Operating voltage at 40 kV, current at 20 A, Cu Kα, λ=0.154 nm), as designed and manufactured by Bruker of Billerica, MA, was used to collect the signal for the 3D structure. The dynamic mechanical analysis (DMA) was performed on a TA Q800 analyzer fitted with a rectangular geometry fixture in tensile mode. Testing was carried out at 0.1% strain, 1 Hz, with a temperature ramp from 25 to 200° C. at 3° C./min.

### Modeling

The coarse-grained molecular dynamics (MD) modeling was performed to study the molecular origin of the high-thermal stability of the preform architecture comprising CNTs/PLA. The model was carried out at a gravitational loading at 320° C.

### CNTs Mass and Volume Ratio of the Nanocomposites

The mass fraction of the composites was determined by heating the nanocomposites in a N2 atmosphere using thermogravimetric analysis (TGA). The CNTs were stable up to 700° C. while the epoxy decomposed at 400° C. The difference between the baseline CNT and epoxy curves to the composite sample gave the mass fraction of CNTs. The nanocomposites have a density of 1.24 g/cm³, which was calculated from the sample's mass and dimensions. The volume fraction (v_{f}) of CNTs in the ordered nanocomposites was determined based on the TGA curves of the CNTs, epoxy and CNTs/epoxy composites. The volume fraction of the CNTs/epoxy nanocomposites was calculated according to the following formula:

$${v}_{f} = 1 - \frac{( 1 - {m}_{f} ) {ρ}_{c}}{{ρ}_{m}} \qquad ( Equation S 1 )$$

where m_{f} is the mass fraction of reinforcement and ρ_{c} and ρₘ are the densities of the composite and the matrix. The epoxy has a density of 1.16 g/cm³, which was calculated from the sample's mass and dimensions.

### Mechanical Measurements of the Nanocomposites

The compression test was carried out an Instron 5985 tester (as designed and manufactured by Instron of Norwood, MA) with a 10-kN load cell with a compression speed of 0.5 mm/min. The dimensions of the cylindrical samples were approximately 5 5 mm (diameter) by 3.2 mm. The compressive modulus of the materials was calculated over the linear stress-strain range. Most samples exhibit a peak stress at which the sample cracks and fails.

### Compressive Strength and Filler Ratio of Nanocomposite and Carbon Fiber Composites in Literatures.

TABLE 1
Comparison of compressive strength and filler ratio
of CAMP printed nanocomposite with other reported
3D printed composites using existing technologies.

| | | | Compressive | Compressive | |
|---|---|---|---|---|---|
| Type of filler/ | Filler | | strength | modulus | |
| polymer | ratio | | (MPa) | (GPa) | Techniques |
| CNT/epoxy | 2.5 | wt. % | 80 | 1.3 | FDM + |
| | | | | | curing |
| MWCNT/epoxy | 0.3 | vol % | 156 | ~ | Molding |
| MWCNT/epoxy | 0.5~3 | | 125~150 | 1.4~1.6 | Molding |
| | wt. % | | | | |
| CNT/epxoy | 0.2~1 | | 132~133 | 3~3.15 | Molding |
| | wt. % | | | | |
| SWCNT/epoxy | 5 | wt. % | 72 | 0.3 | Molding |
| MWCNT/epoxy | 0.5~3 | | 46~60 | 1.3~1.4 | Molding |
| | wt. % | | | | |
| MWCNT/epoxy | 0.5~5 | | 125~155 | ~ | Molding |
| | wt. % | | | | |
| SiO2/epoxy | 0.5~5 | | 121-140 | | |
| | wt. % | | | | |
| CB/epoxy | 0.5~5 | | 119~135 | | |
| | wt. % | | | | |
| MWCNT/epoxy | 0.5~3 | | 125~127 | ~ | Molding |
| | wt. % | | | | |
| Graphene/epoxy | 0.5~3 | | 135~139 | | |
| | wt. % | | | | |
| Graphene/epoxy | 0.1~0.3 | | 110~280 | ~ | Molding |
| | wt. % | | | | |
| Graphene/epoxy | 0.1~0.2 | | 98~105 | ~ | Molding |
| | wt. % | | | | |
| Graphene/epoxy | 1~2 | | 150~200 | ~ | Molding |
| | wt. % | | | | |
| CF/epoxy | 72 | wt. % | 241 | ~ | Lay-up |
| SCF/epoxy | 60 | wt. % | 673 | ~ | DIW |
| CF/epoxy | 70 | wt. % | 250 | ~ | ~ |
| CF/epoxy | 27 | wt. % | 172 | ~ | DIW |
| CNT/epoxy | 25 | wt. % | 381 | 2.3 | Inventive |

work

For clarity, the following terms as used in the Table 1 above are intended to mean: Multi wall carbon nanotubes (MWCNT), Single wall carbon nanotube (SWCNT), CB (carbon black), Carbon fiber (CF), Short Carbon fiber (SCF). Fused deposition modeling (FDM), Mixing and Molding (MM), Direct Ink Writing (DIW), Composite Architected Mesoscale Process (CAMP).

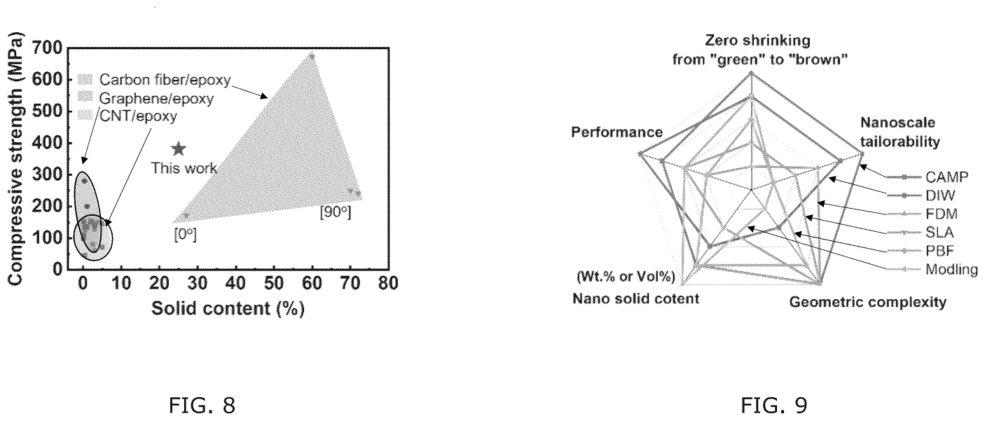

Referring to Table 1 above and FIG. 8, compressive stress was applied to the CNTs/epoxy nanocomposites on the 90° direction of nano reinforcement alignment and shows a compressive strength of 381 MPa and modulus of 2.3 GPa, which are 50% and 30% improvement compared to the neat epoxy (255 MPa for the strength and 1.8 GPa for the modulus). Thus, this mechanical property of the nanocomposite manufactured with the inventive process shows improvement over that of carbon fiber composites, CNTs composites and graphene composites manufactured by related technologies.

Comparison of CAMP Technology with Existing Technologies for Nanocomposites.

TABLE 2
The exceptional features of CAMP technology and the existing technologies.

| | Versatility | | Geometric | Loading | Alignment | |
|---|---|---|---|---|---|---|
| Technology | Reinforcement | Matrix | complexity | (wt %) | freedom | Processability |
| DIW | Silicon carbide | Photocurable | Yes | 63 | Along | Nozzle clogging at |
| | whisker, | Acrylic Resin; | | | printing | reinforcement |
| | MWCNT, | epoxy, thermal | | | direction | agglomeration; |
| | nanoclay, | plastic | | | | resin cures |
| | carbon fiber, | | | | | exothermically; |
| | BN, graphite, | | | | | Limited printing |
| | graphene | | | | | height |
| | oxide, BN-Ag | | | | | |
| FDM | CNT, graphene, | Solid Epoxy, | Yes | 60 | Along | Nozzle cloggy. |
| | BN, micro diamonds, | thermal | | | printing | Loading limitation, |
| | graphite, copper, | plastic | | | direction | post processing |
| | AIN | | | | | needed |
| SLA | SiO₂ | A resin with | Yes | 20 | Controllable | Need additional |
| | nanoparticles, | photoactive | | | alignment | feeding device; |
| | CB, alpha- | monomers | | | | Oven post-curing |
| | alumina powder, | | | | | needed for |
| | titanium | | | | | printed part |
| | carbide, CF, | | | | | |
| | Al₂O₃—ZrO₂ | | | | | |
| PBF | Carbon | Epoxy, thermos | No | 50 | Random | Low printing |
| | nanofiber, CB, | plastic | | | orientation | speed |
| | CNT, CF, | | | | | |
| | yttrium, SiC, | | | | | |
| | nanosilica | | | | | |
| Molding | MWCNT, | Epoxy, thermal | No | 80 | Random | Reinforcement |
| | carbon black, | plastic | | | orientation | agglomeration; |
| | SiO2, | | | | | molds required; |
| | graphene | | | | | waste of |
| | | | | | | material |
| Inventive | CNT, carbon | Epoxy, | Yes | 50 | Customize | No need mold |
| Work | black, | polysiloxane, | | | alignment | |
| | graphene, BN, | thermal | | | | |
| | graphite, | plastic | | | | |
| | copper, micro | | | | | |
| | diamonds, AIN, | | | | | |
| | CF | | | | | |

For clarity, the following terms as used in the Table 2 above are intended to mean: Stereolithography (SLA), Powder bed fusion (PBF), Boron Nitride (BN), Boron Nitride-Argentum (BN-Ag), Aluminum Nitride (AlN), Silicate dioxide (SiO₂), Aluminum oxide-zirconia (Al₂O₃—ZrO₂), Carbon black (CB), Silicon carbide (SIC).

Comparison of Inventive Technology with Representative Existing Technologies for Thermoset Composites Manufacturing

TABLE 3
The features of inventive technology and the existing technologies.

| Composition | CS (MPa) | Method |
|---|---|---|
| 1 wt. % CNT/epoxy | 127 | Molding |
| 27 wt. % CF/epoxy | 172 | DIW |
| 60 wt. % SCF/epoxy | 673 | DIW |
| 2.5 wt. % CNT/epoxy | 80 | FDM |
| 25 wt. % CNT/epoxy | 381 | Inventive |

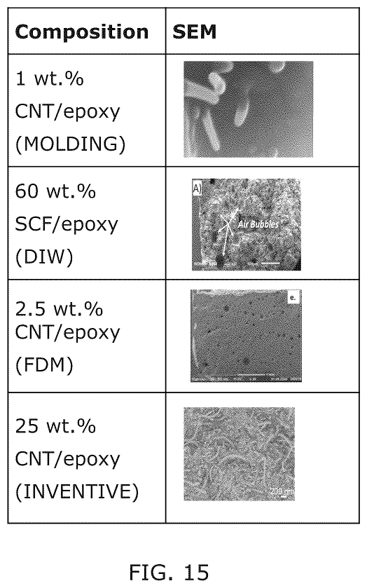

For clarity, the following terms as used in the Table 3 above are intended to mean: Compressive Strength (CS). Further to Table 3, exemplary SEM images for comparison of the inventive technology with representative existing technologies are illustrated in FIG. 15. For clarity, the following terms as used in Table 3 are intended to mean: Direct Ink Writing (DIW) and Fused Deposition Modeling (FDM).

According to another aspect of the invention, process 100 is performed using a printing head attached to an automated robot arm having at least three degrees of freedom, wherein the printing head includes the uniform filament 112, a guide for disposing the filament in a desired location and a dispenser for dispensing the matrix material.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A process for additive manufacturing of a nanocomposite, comprising:
providing a uniform filament comprising a carbon fiber material and a polymer binder;
dispensing the uniform filament to form a preform architecture that defines a first 3-dimensional bulk structure having a first set of volume-defining dimensions;
heating the preform architecture to remove the polymer binder, thereby forming a porous carbon scaffold that defines a second 3-dimensional bulk structure having a second bulk volume, wherein the second bulk volume is equal to the first bulk volume within a tolerance of 10%; and
incorporating a matrix material into the porous carbon scaffold to form a third 3-dimensional bulk structure.

2. The process of claim 1, wherein the carbon fiber material comprises one or more carbon nanopowder, carbon nanotubes (CNTs), nanoflakes, graphene, graphite, copper, micro diamonds, aluminum nitride, boron nitride, SiC fibers, and chopped virgin or recycled carbon fibers.

3. The process of claim 1, wherein the matrix material comprises a material selected from the group consisting of: thermosetting polymer, thermoplastic, metal, ceramic material, and combinations thereof.

4. The process of claim 3, wherein the matrix material comprises a material selected from the group consisting of: epoxy, polysiloxane, and combinations thereof.

5. The process of claim 3, wherein when the matrix material comprises thermosetting polymer or metal, and the matrix material is infiltrated into the porous carbon scaffold in a liquid or molten form.

6. The process of claim 3, wherein when the matrix material comprises ceramic, and the matrix material is incorporated into the porous carbon scaffold as a ceramic precursor solution or preceramic polymer.

7. The process of claim 1, wherein the matrix material comprises a thermosetting polymer, the thermosetting polymer comprising an epoxy.

8. The process of claim 7, wherein the epoxy comprises a two-part system comprising a resin and a curing agent, and the method comprises mixing the resin and the curing agent prior to incorporating the matrix material into the porous carbon scaffold.

9. The process of claim 1, wherein providing the uniform filament comprises mixing the carbon fiber material and the polymer binder into a homogenous mixture, drying the homogenous mixture to form pellets, and extruding the pellets to form the uniform filament.

10. The process of claim 9, wherein the carbon fiber material comprises carbon nanotubes (CNTs) and the uniform filament is extruded in a printing direction, wherein the CNTs in the extruded filament are oriented along the printing direction.

11. The process of claim 10, wherein the uniform filament is extruded through a nozzle that causes shear-induced alignment of the CNTs.

12. The process of claim 11, wherein the CNTs in the extruded uniform filament form a locally aligned, globally distributed structure, in which the CNTs and the polymer binder form an interconnected molecular network with CNT/polymer-binder entanglement.

13. The process of claim 12, wherein the fiber material is a functionalized fiber material comprising a percentage of functional groups that form hydrogen bonds between the polymer binder and the functional groups in the interconnected molecular network.

14. The process of claim 9, wherein heating the preform architecture comprises carbonizing the preform architecture in an inert atmosphere at 1100° C.

15. The process of claim 1, wherein the step of dispensing the matrix material comprises applying vacuum pressure to drive the matrix material into the carbon scaffold.

16. The process of claim 16, further comprising curing the matrix material to form the nanocomposite after dispensing the matrix material into the carbon scaffold.

17. The process of any one of the foregoing claims, wherein the fiber material comprises carbon nanotubes and the polymer binder comprises a polylactic-acid (PLA) biopolymer.

18. The process of claim 18, wherein the uniform filament comprises greater than 25% fiber material by weight.

19. The process of claim 18 wherein the uniform filament comprises greater than 30% fiber material by weight.

20. The process of claim 1, wherein dispensing the uniform filament to form the preform architecture comprises dispensing a plurality of layers of uniform filament, one layer on top of another.

21. The process according to claim 1, comprising performing the process using a printing head attached to an automated robot arm having at least three degrees of freedom, wherein the printing head includes the uniform filament, a guide for disposing the filament in a desired location, a heater spaced from the guide for curing the polymer material in the uniform filament, and a dispenser for dispensing the matrix material at a distance from the heater.

22. The process of claim 1, including forming the 3-dimensional structure with a tunable geometry.

23. A nanocomposite material comprising a product of the process of claim 1.

24. The nanocomposite material of claim 23, wherein the nanocomposite material comprises a monolithic catalyst, a battery electrode, a sensor, or a combination thereof.

25. A system for additive manufacturing of a fiber reinforced composite, the system comprising:
a filament dispenser configured to extrude a homogenous mixture of fiber material comprising carbon nanotubes (CNTs) and polymer binder through a nozzle to form a uniform filament;
means for moving the filament dispenser relative to a dispensing location in a filament deposition direction to form a preform architecture defining a bulk 3-dimensional structure having a first bulk volume with the CNTs shear-aligned in the filament deposition direction;
a heater configured to heat the preform architecture to remove the polymer binder, thereby forming a porous carbon scaffold defining a second 3-dimensional bulk structure having a second bulk volume, wherein the second bulk volume is equal to the first bulk volume within a tolerance of 10%; and
a matrix material applicator configured to incorporate a matrix material into the porous carbon scaffold.
